(19) United States
(12) Patent Application Publication
(10) Pub. No.: US 2012/0107054 A1
(43) Pub. Date: May 3, 2012

(54) BASE STRUCTURE FOR OFF-SHORE WIND TURBINES WITH NOISE REDUCTION

(75) Inventor: Frank Baumfalk, Dotlingen (DE)

(73) Assignee: HILGEFORT GMBH, Dinklage (DE)

(21) Appl. No.: 13/213,307

(22) Filed: Aug. 19, 2011

(30) Foreign Application Priority Data
Aug. 20, 2010 (DE) 10 2010 035 025.7
Aug. 20, 2010 (DE) 10 2010 035 035.4

(51) Int. Cl. E02D 5/54; G01V 1/04

(52) U.S. Cl. 405/227; 181/115

(57) ABSTRACT

The invention relates to a base structure for an off-shore wind power installation having preferably three base piles, each of which is of a length such that when installed at an installation location it extends from a seabed to above a sea level, wherein the base pile has a driving pile which is guided in its interior at least portion-wise for anchoring in the seabed, and at least one support structure for mounting the wind power installation. Furthermore at least a portion of the base pile has a wall comprising a plurality of layers, wherein there is provided al least an inner layer and an outer layer, between which, is arranged at least one intermediate layer which has a sound-reducing core material, in particular concrete. The invention also relates to a method and an apparatus of reducing noise emissions when erecting a base structure.

The invention relates to a base structure for an off-shore wind power installation having at least one base foundation pile, preferably three base foundation piles, wherein the base pile is of a length such that when installed at an installation location it extends from a seabed to above a sea level, wherein the base pile has a driving pile which is guided in its interior at least portion-wise for anchoring in the seabed, and at least one support structure for mounting the wind power installation.

The invention further also concerns a method of reducing noise emissions when erecting a base structure, in particular a base structure as set forth in one of the preceding claims, for an off-shore wind power installation, wherein the base structure has at least one base pile and a driving pile guided therein, and to a noise reduction apparatus.

Known base or foundation structures for off-shore wind power installations usually form the transition from the wind power installation (WPI) to the seabed and are intended to ensure secure anchoring in the seabed. Specifically off-shore wind power installations are increasingly being located at some distance from the coast and as a result frequently in depths of water of up to 50 meters or more. By virtue of the ambient conditions prevailing at such an installation location and the wind and wave loads which generally act on the base structure and the hydraulic structure, correspondingly high demands are made on anchorage of the base structure in the seabed and the base structure carrying the hydraulic structure itself. In particular locating the base structures at such locations involves a high level of complication and effort.

Basically various different possible ways of locating base structures on the seabed are known. For example simple gravity constructions are known, in which there is arranged at the lower end of a base pile, a large weight, for example a concrete member, by means of which the base structure is located on the seabed. It will be noted however that this is only safe for shallow depths of water of up to about 20 meters. For greater depths of water, base structures are usually employed, which are anchored in the seabed by means of so-called driving piles. Here too a distinction can be drawn between various fundamental constructions.

EP 1 673 536 B1 describes for example a base structure for an off-shore wind power installation, having six base piles with respective driving piles which are at least portion-wise guided in the interior of the respective base piles, for anchorage in the seabed. The base structure further has at least one support structure for mounting the pylori of the wind power installation, wherein the support structure connects the upper ends of the base piles together. In that case, after piling of the driving piles, a predetermined lengthwise portion is produced, in which the driving piles are received by the base piles. To prevent relative movement between the base piles and the driving piles and thereby possibly cause loosening of the anchorage of the base structure in the seabed, an adhesive join is made in a part of the overlap region between the outside of the driving pile and the inside of the base pile. The relatively narrow adhesive join between the outside of the base pile and the inside of the driving pile means that on the one hand there is the risk that the adhesive tears and thus the driving pile is again movable relative to the base pile. In addition, it is in the region of the seabed that the highest moment caused by the wind and wave loads acts on the base and driving piles of the base structure so that the constant changes in load shortly beneath the overlap region of the piles can result in deformation and possibly bending of the walls of the driving piles, which at any event can have a detrimental effect on the anchorage thereof and thus on the operationally reliable long-term function of the base structure.

Driving of the driving piles is usually effected by means of pile drivers acting on a head end of a driving pile. As a driving pile is driven into the seabed approximately as far as a depth approximately corresponding to the depth of the water at the installation location, the pile driving operation takes several hours. That involves considerable levels of noise emission. Thus for example in the case of tripod constructions which have three base piles which extend from the seabed to above the surface of the water, noise levels of sometimes 180 dB are measured at a 50 meter distance relative to the base structure in the water. On the one hand that represents a severe and unreasonable strain on workers and divers, while on the other hand the sound waves are so strong that fishes can be killed thereby. In addition the statutory regulations have changed in that area and tend to allow only lower levels of noise emission.

Therefore the object of the present invention is to provide a base structure, a method and a noise reduction apparatus, by which the noise emitted when driving the driving pile can be at least partially absorbed, and in particular can be absorbed to a greater degree than by means of known apparatuses and methods.

According to the invention the object is attained by a base structure having the features of claim 1, by a method as set forth in claim 10 and by a noise reduction apparatus as set forth in claim 15. Advantageous developments and configurations of the invention are recited in the appendant claims.

In the case of such a base structure for an off-shore wind power installation having at least a plurality of base piles, wherein each base pile has a driving pile guided in its interior at least in portion-wise manner for anchorage in the seabed, and at least one support structure for mounting the pylori of a wind power installation, wherein the support structure connects the upper ends of the base piles together, it is provided that, after installation of the base structure on the seabed and after the driving piles have been driven in, the base pile and the driving pile have a region of overlap on a predetermined lengthwise portion, wherein in the overlap region of the piles, in at least portion-wise manner, the gap between the piles, and over a portion of the overlap region and in a part beneath the overlap region, the free internal cross-section of the driving pile is filled with a hardening filling material.

By means of such a strong structure around the overlap region of the base piles and the driving piles which are region-wise accommodated by the base piles, in particular buckling or kinking of the pile walls is advantageously prevented in the region of the seabed by the filling material which has portion-wise hardened within the driving pile and between the base pile and the driving pile. The filling material which extends to beneath the overlap region in the interior of the driving pile imparts thereto optimum stiffness over a predetermined part thereof, whereby the driving pile can be made up from a single-walled tube. The hardening filling material which preferably respectively extends from below to above the overlap region, such as for example concrete, advantageously produces a base structure, by means of which it is possible without any problem to guarantee an operationally reliable long-term function of the at least required period of 20 years. Particularly in the case of tripod structures having three base piles which are arranged in an equilateral triangle in mutually parallel relationship and which extend from the seabed to above the surface of the water, wherein the upper ends of the base piles are connected to a support structure, that design configuration is advantageous and a rigid, durable structure is achieved.

In addition, in the case of such base structures, it can be provided that the base pile in the foot region has a guide for the driving pile, which reduces the free cross-section of the base pile at the inner peripheral surface. The use of a guide has the advantage that the driving pile is axially movably guided during the driving operation in particular at the beginning of the driving works, so that the driving pile is driven into the seabed with its center line preferably coaxially with respect to the center line of the base pile. That is intended advantageously to prevent the driving pile from running out. In that case the guide is provided approximately over half of the overlap region of the two piles in the gap between the inside of the base pile and the outside of the driving pile at least region-wise over the periphery thereof. The guide can be for example in the form of a sleeve. Preferably a plurality of plates are used, the longitudinal axes of which extend parallel to the center line of the base pile and extend radially from the inside of the base pile in the direction of the center line.

Optionally the base pile has a bottom ring with a seal which seals off the gap relative to the driving pile, whereby on the one hand the ingress of sea water, as well as pieces of rock and mud, in particular into the gap in the region of the guide, is avoided during and after the pile driving operation. That therefore prevents unwanted fouling of the portion of the base pile and the driving pile, that is to be subsequently concrete-filled. On the other hand the seal in the region of the gap also prevents the escape of the subsequently introduced filling material. Therefore the filling material to be hardened always remains at the same level in the gap between the base pile and the driving pile and can accordingly involve a fixed connection to the surfaces of the respective pile walls. To produce the seal on the bottom ring, it is possible for example to use a felt or another suitable material which is suitable for preventing the entry of mud. In addition, a bursting disk can also be fitted on the bottom ring from below, which disk effectively closes the free cross-section of the driving pile which is preferably in the form of a tube and which is thus downwardly open, and thus already prevents the entry of sea water when lowering the construction part serving to produce the base structure, on to the seabed; the bursting disk is already destroyed by the driving pile which is preferably driven perpendicularly downwardly, when the construction part is placed on the seabed but at the latest with the beginning of the pile driving operation, and in that case the bursting disk does not represent any impediment for the pile driving operations to be performed. Preferably however the base pile is flooded with water, for example sea water, in the pile driving operation, so that the buoyancy of the base structure is reduced and the operation of driving the pile into the seabed can be effected unhindered.

Alternatively it may be advantageous not to provide a seal. Thus when the base structure is lowered from a ship on to the seabed water can pass controlledly and uniformly into the base piles. The risk of a suddenly occurring leak in a sealed base pile causing a sudden shift in the center of gravity and thus tipping of the base structure is reduced. The seal and the bursting disk can then be omitted.

The base pile preferably has an inner tube providing its inner peripheral surface and an outer tube providing its outer peripheral surface, a core material being arranged between the inner tube and the outer tube. Such a wall structure provides a structurally advantageous possible way of forming the base piles. The sandwich structure of the pile wall on the one hand improves the stiffness of the base pile while on the other hand the amount of steel usually employed to produce the base pile can advantageously be reduced thereby. Due to the increased stiffness, both the diameter and also the overall thickness of the inner and outer tubes can be markedly minimised, which at the same time advantageously improves the economy of such base structures according to the invention by virtue of reduced production and material costs. The core material as the intermediate layer between the inner and outer tubes is in particular additionally strengthened with reinforcement which is arranged in the form of concrete reinforcing steel bars or in the form of a hollow-cylindrical lattice in the core material. It is provided in that case that the reinforcement is always completely enclosed by the core material and is arranged at a spacing relative to the inside of the outer tube and the outside of the inner tube.

According to the invention, in a base structure of the kind set forth in the opening part of this specification, it is provided that at least a portion of the base pile has a wall comprising a plurality of layers, wherein there is provided at least an inner layer and an outer layer, between which is arranged an intermediate layer which has a sound-reducing core material, in particular concrete.

The configuration according to the invention of the base pile or piles of the preferred tripod construction of the base structure reduces levels of noise emission. After the base structure is installed on the seabed the base piles extend from the seabed to above the surface of the water. The driving piles are disposed in the base piles and guided therein. Because the base pile has a plurality of layers, wherein there are provided at least an inner layer and an outer layer, between which there is at least one intermediate layer which has a noise-reducing core material, the transmission of noise in the pile driving operation from within the base pile through the wall of the base pile to the sea water surrounding the base pile is reduced. Such a core material can be for example concrete or can have concrete such as for example steel reinforced concrete. The intermediate layer is preferably of a thickness of at least 6 cm, in particular at least 8 cm. That effectively reduces emitted noise.

Furthermore the amount of steel required for production of the base structure is advantageously reduced by means of such a configuration according to the invention in respect of a wall used for producing subregions of the base structure. Both the inner layer and also the outer layer of the wall in that arrangement are of a smaller overall thickness than the wall thicknesses which are otherwise usually required to provide the known base structures. Specifically due to the intermediate layer between the inner layer and the outer layer in the form of a core material, it is advantageously also possible to increase the strength or stiffness of the wall in spite of the markedly reduced amount of steel. In that case the overall wall thickness of the wall according to the invention of the subregion of the base structure due to the use of the core material between the inner and outer layers, which is preferably made from a steel reinforced material, can be greater than the wall thickness of conventional base structures. In spite of a greater overall wall thickness, the base structure according to the invention, in comparison with a conventional base structure, can be of a lesser inherent weight and can thus be more easily transported to its installation location.

It is advantageously provided in a development of the invention that the inner layer is in the form of an inner tube and the outer layer is in the form of an outer tube extending at a spacing relative to the inner tube. The use of an inner tube and an outer tube, between which the core material is introduced preferably completely or over the full periphery, represents a structurally advantageous possible option for the design configuration of given portions of the base structure. The cylindrical configuration which is preferred in that respect permits advantageously uniform load application and load distribution over the entire structure of the in particular tubular components of the base structure, which in turn has an advantageous effect on the operationally reliable long-term function of the base structure. In addition uniform distribution of the intermediate layer is advantageous for the uniform reduction in the level of noise emission caused by the pile driver. In that case the core material is preferably joined over the full surface area involved to the outside of the inner tube and the inside of the outer tube. There is for example a positively locking connection between the core material and the inner and outer tubes respectively. The core material can involve for example a material which can be subsequently introduced between the inner and outer tubes and which gradually hardens and thus imparts a good noise-absorbent property and relatively high stiffness to the components of the base structure, that are equipped with that material. In a preferred development of the invention, the base structure has a gas feed device for feeding gas under pressure, in particular air, into a gap between base pile and driving pile. According to the invention the base pile extends in its erected condition from the seabed to above the surface of the water. The driving pile is guided in the base pile. A gap is provided between the driving pile and the base pile. That gap is flooded with water, for example sea water. Consequently, in the operation of driving the driving pile, the noise produced by the pile driving operation is transmitted through the water arranged in the gap between the driving pile and the base pile to the base pile and through same to the surrounding water. Preferably there is provided a gas feed device with which gas under pressure is introduced into the gap between the base pile and the driving pile so that a curtain of gas bubbles is formed in the gap. Preferably the pressurised gas is introduced into the gap at a lower end of the base pile, near the seabed. The bubbles then rise in the gap and form a curtain. That substantially reduces the transmission of noise from the driving pile through the water in the gap to the base pile. The sound waves are broken at each transition from water to gas and from gas to water, whereby the noise is reduced. It is therefore advantageous to form a curtain comprising a plurality of bubbles. To be able to effectively break waves of different lengths, it is also preferable for the individual bubbles to be of different diameters. Preferably between about 30% and 60%, preferably about 50%, of the volume is filled with gas bubbles. Thus an optimum number of transitions between gas and water is achieved, whereby the noise can be effectively broken and absorbed. Because the gap is provided between the driving pile and the base pile and the base pile extends to above the surface of the water, a defined space is formed for the gap and the curtain or the gas bubbles are not flushed away by a flow from the base structure. In addition the bubbles increase in size when rising due to the drop in pressure in the direction of the surface of the water, whereby the noise reduction effect is further enhanced. In the case of preferred tripod base structures moreover the three base piles are oriented substantially perpendicularly relative to the seabed or vertically. In that way the gas bubbles can be introduced distributed uniformly around a periphery around the driving pile in the gap. In the case of base piles which are arranged inclinedly, the gas bubbles would collect on one side, whereby the sound-absorbent effect would scarcely occur. It is further preferred if there is a foaming agent feed device for feeding foaming agent, in particular soap substances, into a gap between base pile and driving pile. Preferably such foaming agents, in particular soap substances, can ecologically break down and thus do not cause environmental pollution. Gas bubbles can be still more effectively produced by such foaming agents. In addition the gas bubbles remain separated from each other as they rise and a uniform gas bubble curtain for noise absorption can be produced in the gap between the driving pile and the base pile.

In a further preferred embodiment the gas feed device has a feed ring and a feed hose, wherein the feed ring is arranged at a foot end of the base pile and is connected to the feed hose. The feed ring is preferably connected to the base pile before the base structure is set up on the seabed. Preferably the feed ring is releasably connected to the base pile so that it can be removed from the base pile after the setting-up operation and after driving of the driving pile. Alternatively the feed ring can also be fitted only after the base pile has been set up. For that purpose for example weights can be arranged on the feed ring. Because the feed ring is connected to a feed hose, it is possible for gas under pressure to be introduced into the gap from above the surface of the water. Thus it is possible to regulate the gas bubble curtain from above the surface of the water, for example from an installation ship. That simplifies the method.

Preferably the feed ring has a plurality of gas outlets for the discharge of gas flows into the gap between the driving pile and the base pile, wherein the gas outlets are preferably substantially uniformly distributed on a ring periphery. As a result the gas bubble curtain is produced uniformly, whereby noise absorption occurs uniformly in all directions. In that arrangement the gas outlets are preferably directed in the direction of the surface of the water. That further permits uniform introduction. Preferably there are provided gas outlets which involve different opening diameters. In that way it is possible to produce gas bubbles of differing sizes, whereby absorption is further improved. It is further preferable for nozzle elements or the like to be arranged at the gas outlets. In that way it is possible for the size of the bubbles and the dispersion thereof to be further influenced.

In a further preferred embodiment of the invention or in a further aspect of the invention the aforementioned object is attained by a noise reduction casing which is substantially cylindrical and which radially externally encloses the base pile. Particularly preferably such a noise reduction casing is used in combination with a base structure in accordance with one of the above-mentioned preferred embodiments. The noise reduction casing can preferably be arranged reversibly on the base structure. The noise reduction casing can accordingly be arranged for example prior to location of the base structure around the base pile or each pile of the preferred tripod base structure and the base structure can then be set up on the seabed together with the noise reduction casing or casings. The noise reduction casing is adapted to further absorb noise which is emitted from the base pile to the surrounding water by virtue of an operation of driving the driving pile in the interior of the base pile. Preferably the base pile is of a multi-layer configuration with a noise-absorbent core material in accordance with the above-described aspects. Thus noise which is produced when driving the driving pile is effectively absorbed. The noise reduction casing can then be removed again after termination of the driving operation and is thus re-usable.

Preferably in that arrangement a substantially cylindrical gap is provided between the base pile and the noise reduction casing and a gas feed device for feeding gas under pressure, in particular air, into that gap, is provided in the gap. In that way it is possible to produce a gas bubble curtain in the gap between the base pile and the noise reduction casing, whereby noise can be further effectively absorbed. The gas feed device is preferably designed in accordance with the features of the above-described gas feed device. Preferably therefore when the base structure is set up, there are provided two gas feed devices, one for the gap between the driving pile and the base pile and one for the gap between the base pile and the noise reduction casing. For the preferred embodiments and configurations of the gas bubble curtain as well as the gas feed device and also a feed of foaming agents, reference is directed to the foregoing description.

Preferably the noise reduction casing has a chloroprene rubber material and/or a polyamide fiber fabric. Chloroprene rubber material is provided with many small gas bubbles, whereby that material can advantageously be used as a noise reduction casing. Polyamide fiber fabric serves to reinforce the chloroprene rubber material so that the noise reduction casing is not pressed against the base pile in the event of an afflux flow against the base structure or base pile, whereby it is possible to maintain the gap between the base pile and the noise reduction casing and thus also to maintain the gas bubble curtain substantially homogeneously over the periphery. In that way the noise absorption capability is substantially improved. Naturally other materials with similar noise-absorbent properties are also preferred, as well as other reinforcing materials. For example it is equally possible to use a melamine hose while wire cables can be used as reinforcement.

Such a noise reduction casing can be in one piece or can have individual segments. Preferably the noise reduction casing can be axially divided into a plurality of segments. The individual segments are preferably of a slightly frustoconical or conical shape so that they can be arranged substantially coaxially one within the other. In that way the noise reduction casing can be pushed together to save space. The individual segments preferably have projections or abutments so that, when the individual segments which have been pushed one into the other are pulled apart or when the noise reduction casing is erected, the segments cannot be separated from each other and thus form a substantially cylindrical casing in the condition of being pulled out. To fix the individual segments relative to each other in an extended or erected condition, suitable fixing means can be provided thereon such as for example latching projections, clips, clamping screws, tightening screws, catches and the like. Preferably the individual segments also have a reversibly closable longitudinal seam. That longitudinal seam can be reversibly closed for example by means of hook-and-loop fasteners, hooks, catches, belts, clips, tightening screws, zip fasteners and the like. In that way the individual segments can also be opened along the longitudinal axis, whereby they can be stowed in a space-saving fashion and fitment and dismantling are simplified.

It is advantageously provided in a development that the driving pile has a bulkhead which is arranged at a spacing beneath the overlap region and which closes off the free internal cross-section of the driving pile. The entry of water or mud by way of the driving pile which is of a hollow-cylindrical configuration into the interior of the base pile is avoided by means of such a bulkhead in the operation of driving the driving pile so that the free cross-section of the driving pile is filled with seabed only as far as the bulkhead. In addition the bulkhead serves as a filling limit for the filling material which is to be introduced into the driving pile head and which hardens therein and which imparts improved stiffness to the driving pile. The bulkhead is in particular a plate body which extends with its plate plane perpendicularly to the center line of the driving pile and which is sealingly connected in peripheral relationship to the inside of the wall of the driving pile, in particular being welded thereto. In that case the bulkhead is arranged approximately at a spacing beneath the end of the base pile, that corresponds to the length of the overlap of the piles.

To avoid an excessive build-up of pressure in the interior of the driving pile and thus an unnecessary counteracting force in the pile driving operation venting of air from the interior of the driving pile is to be provided. For that purpose in its pile wall beneath the bulkhead the driving pile has at least one opening. Accordingly air in the driving pile can escape in the driving operation so that the constituents of the seabed can rise up in the free cross-section of the driving pile to below the bulkhead. In that respect it is advantageous if a plurality of openings are provided beneath the bulkhead over the length of the driving pile and at the same time a plurality of openings are arranged in the pile wall at the same height level distributed around the periphery of the driving pile. In addition each opening for air venting in the wall of the driving pile can be sealed with a suitable material which dissolves for example upon contact with water and thus the openings are successively opened for air venting purposes in the longitudinal direction in the wall of the pile.

In an optional configuration, at its outside peripheral surface, the driving pile has a radially outwardly extending step as an abutment against the guide of the base pile, by means of which the driving pile is brought into contact in positively locking relationship in the longitudinal direction with in particular the plates forming the guide at the inside of the base pile and exerts a holding force perpendicularly downwardly on the base pile. The step which extends in an annular shape along the peripheral surface of the driving pile is in particular arranged in spaced relationship with the upper end of the driving pile so that there is always a given portion of the driving pile that projects freely into the base pile above the guide. That provides a gap between the outside of the driving pile and the inside of the base pile, into which gap the filling material can be introduced. The radially outwardly extending peripheral surface of the step can be at the same time in the form of a guide surface for support against the inside of the base pile. That further improves guidance for the driving pile within the base pile and at the same time advantageously prevents the driving pile from running out in the pile driving operation. The step can be in particular a flange-like ring body welded to the outer peripheral surface of the driving pile.

Another development provides that the driving pile is at least portion-wise provided with reinforcement on the inside of the pile wall. In particular the subsequently introduced filling material is strengthened by means of the reinforcement, while in addition its tensile strength is increased and thus the load-bearing capability of the piles is markedly improved in the region of the seabed. Specifically forces acting dynamically on the base structure can be absorbed without any problem by the reinforced component structure of the base. In particular concrete reinforcing steel in the form of bars is used as reinforcement, which are arranged on a predetermined part-circle diameter in spaced relationship with the inside of the driving pile. In place of individual bars it is also possible to use a cylindrical reinforcing cage which extends similarly to a mesh on a uniform radius around the center line of the driving pile.

The aforementioned object is further attained by a method of the kind set forth in the opening part of this specification of reducing levels of noise emission when erecting a base structure, in particular a base structure as set forth in one of the aforementioned preferred embodiments, for an off-shore wind power installation, wherein the base structure has at least one base pile and a driving pile guided therein, wherein the method comprises the step: producing a curtain of gas bubbles in a water-flooded gap between the base pile and the driving pile. Preferably at the same time the driving pile of the base structure is driven into the seabed. In that way noise produced by driving the driving pile is absorbed by the gas curtain.

Preferably the method further includes the step of: arranging a noise reduction casing outside the base pile in such a way that it radially substantially encloses the base pile, a substantially cylindrical gap remaining free between them. Such a noise reduction casing preferably has the features of a noise reduction casing as described hereinbefore and is adapted to further absorb noise emissions. Preferably there is also the step of: producing a curtain of gas, in particular air bubbles, in a water-flooded gap between the noise reduction casing and the base pile. The level of noise emission is further reduced by that gas bubble curtain in the intermediate space between the noise reduction casing and the base pile. The gas bubble curtain between the noise reduction casing and the base pile preferably involves the features of a gas bubble curtain as described hereinbefore. In particular it is preferred that, when driving the driving pile the volume proportion of the gas in the gap between the noise reduction casing and the base pile and/or in the gap between the base pile and the driving pile is greater than 40%, preferably greater than 45%, in particular greater than 50%. It will be appreciated that, by virtue of the pressure drop between the surface of the water and the seabed, that ratio is not fixed but varies and in particular the ratio increases from the seabed in the direction of the surface. It has been found that noise is particularly effectively absorbed with a ratio of greater than 50%. There is no need to achieve a volume proportion which is as large as possible, but a range of greater than 50% is preferred.

It is further preferred that the method includes the step of: introducing a foaming agent, in particular soap substances, into a water-flooded gap of the base structure. Such a gap is for example the gap between the driving pile and the base pile and/or a gap between a noise reduction casing and the base pile. That improves bubble formation and the noise can be more effectively absorbed. The feed can be implemented for example by means of a foaming agent feed device having the above-mentioned features.

In a further aspect the aforementioned object is attained by a noise reduction apparatus for reducing sound emissions when erecting a base structure, in particular a base structure in accordance with one of the foregoing preferred embodiments, for an off-shore wind power installation, comprising a noise reduction casing which is adapted to preferably substantially cylindrically radially externally enclose a base pile and has in particular a chloroprene rubber material and/or a polyamide fiber fabric, and at least one gas feed device for feeding gas under pressure, in particular air, into a gap between the base pile and a driving pile of the base structure and/or into a gap between the noise reduction casing and the base pile. Such a noise reduction apparatus can be used when erecting a base structure. After a base pile has been placed on the seabed the noise reduction casing can be fitted over the base pile and the gas feed device can be arranged in a foot region. It is however equally preferred for the noise reduction casing already to be pre-fitted in the factory or on a fitting ship. Then, when driving the driving pile, a gas bubble curtain can be produced, by which the noise produced when driving the driving pile can be absorbed. Such a noise reduction apparatus is accordingly re-usable and can be employed in relation to a plurality of base structures. In an alternative the noise reduction apparatus has a plurality of noise reduction casings which are arranged in substantially mutually concentric relationship. Provided between the plurality of noise reduction casings are a plurality of gaps in which a plurality of gas bubble curtains can be produced. That means that the noise can be even more effectively absorbed.

An embodiment of the invention showing further inventive features is illustrated in the drawing in which:

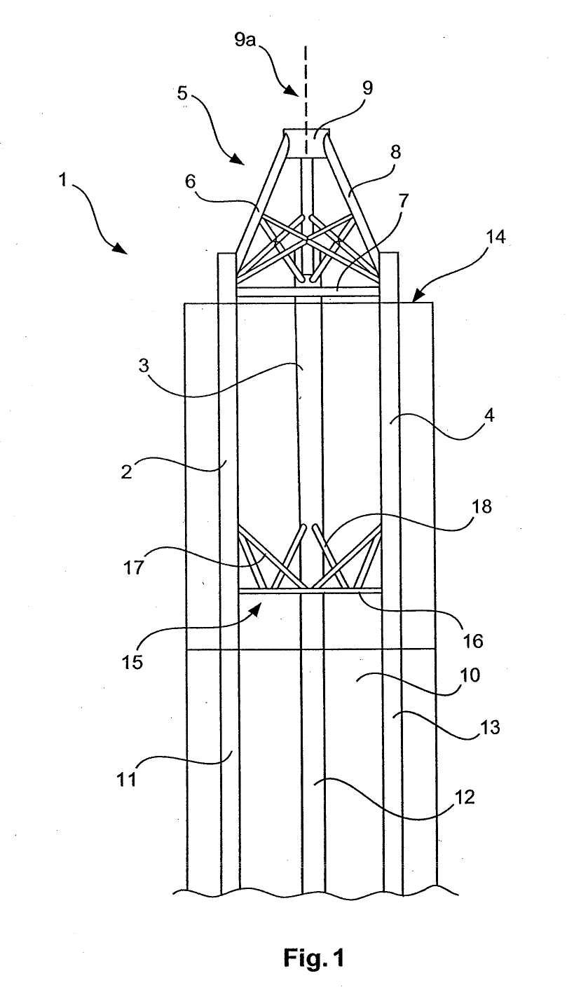

FIG. 1 shows a view of a base structure according to the invention,

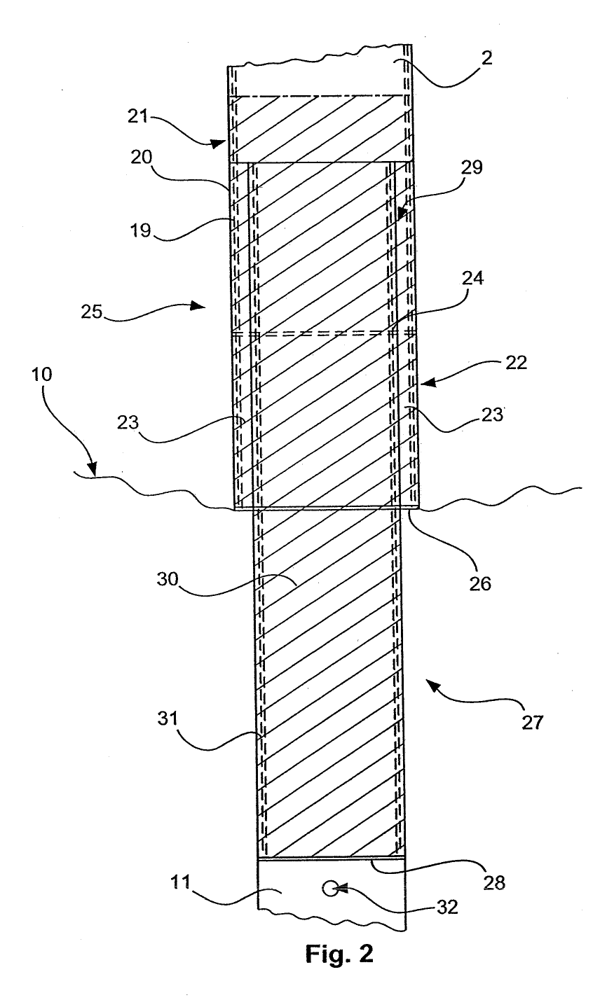

FIG. 2 shows a view of a portion of a base pile used for anchorage in the seabed and the driving pile guided therein, in section,

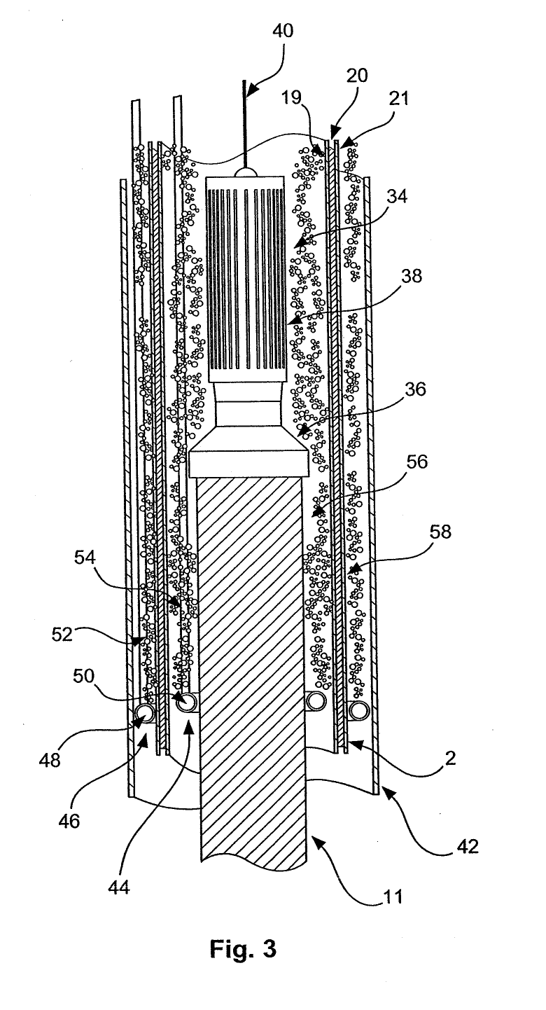

FIG. 3 shows a sectional view of a base pile with driving pile, sound reduction apparatus and air curtain,

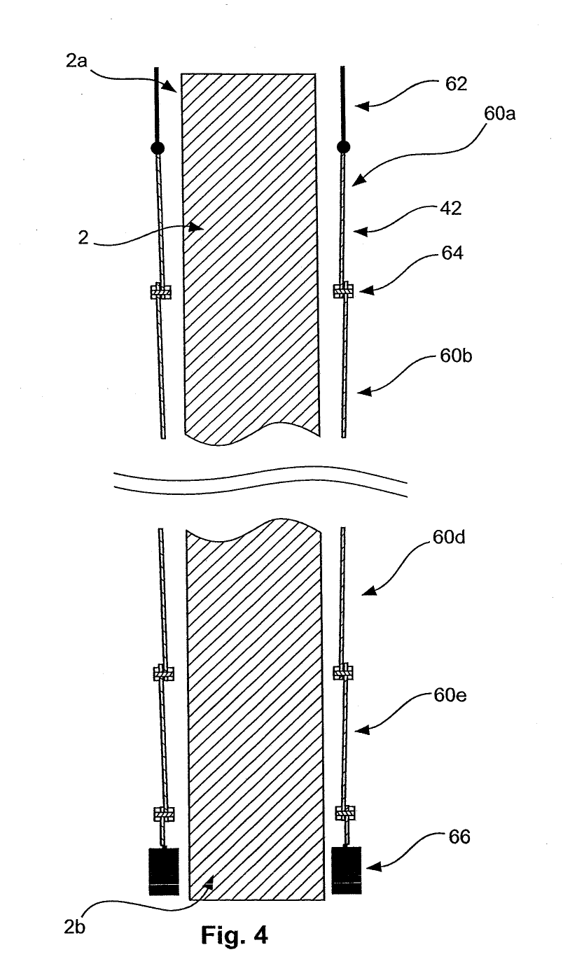

FIG. 4 shows a longitudinal section of a base pile with a sound reduction casing in a second embodiment, and

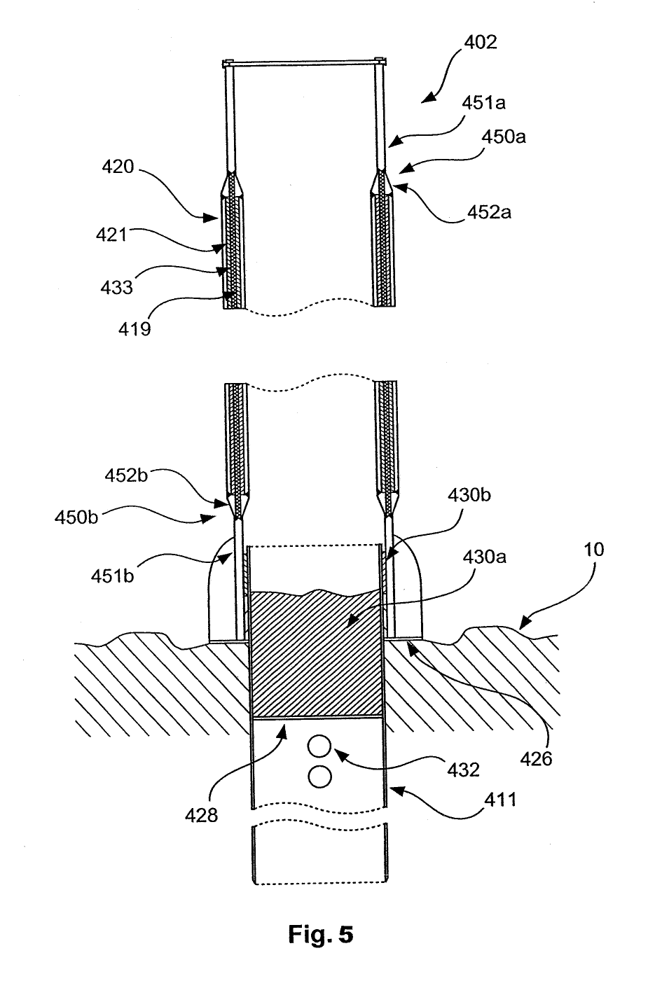

FIG. 5 shows a fully sectioned overall view of a base pile with driving pile.

Reference 1 denotes a base or foundation structure for an off-shore wind power installation, which has three vertically extending base piles 2, 3 and 4 and a support structure 5 having a plurality of bars 6, 7, 8 and a central mounting 9 for the pylori of a wind power installation (not shown). The base piles 2, 3, 4 stand on the seabed 10, driving piles 11, 12, 13 fixedly connected thereto projecting out of same for anchorage in the seabed. To ensure secure anchoring the driving piles 11 through 13 have a portion which is driven into the seabed and which approximately corresponds to the depth of water at the installation location. The support structure 5 connects at the same time the upper or free ends of the base piles 2, 3, 4 together above the water line 14 so that forces acting on the base structure 1 or the wind power installation, due to wind and wave loads, are advantageously distributed to all three base piles 2 through 4 and their driving piles 11 through 13. In addition, provided at a predetermined depth of water above the seabed 10 is a second support structure 15 having bars 16, 17, 18 which advantageously fixes the three base piles 2 through 4 relative to each other during movement to the installation location or during the pile driving operation. The support structure 15 can be removed after installation. It is not required for the base structure but is only advantageous. Both the base piles 2 through 4 and the driving piles 11 through 13 and also the posts or bars 6 through 8 of the support structure 5 are preferably of a cylindrical configuration.

When erecting the base structure 1 it is firstly placed on the seabed 10 in the manner shown in FIG. 1. The driving piles 11, 12, 13 are already arranged in the base piles 2, 3, 4 before the installation procedure. Thus there is no need for the driving piles 11, 12, 13 to be introduced into the base piles 2, 3, 4 from above after the base structure 1 has been installed. Precise alignment and introduction of the driving piles 11, 12, 13 can thus be eliminated. After the installation procedure the driving piles 11, 12, 13 are then driven into the seabed 10 by means of a pile driver 34 (FIG. 3).

FIG. 2 shows a partial view of one of the base piles 2 through 4 with one of the driving piles 11 through 13 accommodated therein in section and is intended in particular to more clearly show the structure thereof. Each of the base piles 2 through 4 has a wall of a plurality of layers 19, 20, 21 of different materials. Introduced between the inner, preferably metallic layer 19 and the outer metallic layer 20 is an intermediate layer 21 of a core material such as for example concrete. In its foot region each base pile 2 through 4 has a guide 22 for the driving pile, that reduces its free cross-section at the inner peripheral surface, whereby the driving piles are prevented from running out during the pile driving operation. In that arrangement the guide is formed by means of four plates 23, 23′ which are arranged at the inner layer 19 of a base pile and which extend at an angle of 90 degrees relative to each other at the inside of the inner layer in the longitudinal direction and extend radially inwardly. To provide a stable end position for the driving piles 11 through 13 in a respective base pile 2 through 4 provided at the outside of each driving pile at a predetermined spacing beneath the upper end is an annular abutment 24 which comes to lie on the upper ends of the plates 23, 23′ of the guide 22 so that portions of the two piles provide relative to each other an overlap region 25 of a predetermined length. Provided at the underside of each base pile there is also a bottom ring 26 having a seal for sealing off the guide gap relative to the driving pile. Each driving pile 11 through 13 has a delimited driving pile head 27 delimited by a bulkhead 28 which is arranged at a spacing from its upper end, that approximately corresponds to double the length of the overlap region 25, closing off the free internal cross-section thereof. Both the driving pile head 27 above the bulkhead 28 and also the gap 29 between the outside of the driving pile and the inside of the base pile as well as the part of the base pile above the overlap region 25 are filled with a hardening filling material 30. To improve the tensile strength of the filling material 30, a reinforcement 31 of for example bars is arranged at least portion-wise on the inside of the driving pile wall. Each driving pile 11 through 13 also has beneath the bulkhead 28 at least one opening 32 in its pile wall for advantageous air venting during the operation of driving the pile into the seabed 10.

The intermediate layer 21 is formed from a noise-insulating core material. Such a noise-insulating core material can include for example concrete. The intermediate layer 21 is preferably of a thickness of 8 cm.

FIG. 3 illustrates a portion of a base pile 2 with a driving pile 11 during the pile driving operation. The base pile 2 has three layers 19, 20, 21. The inner layer 19 is in the form of a steel tube arranged concentrically in an outer steel tube forming the outer layer 21. A noise-insulating intermediate layer 20 is arranged between the two layers 19, 20. In this embodiment the intermediate layer 20 is made of concrete and is of a thickness of about 8 cm. The driving pile 11 is arranged substantially concentrically in the base pile 2. At the upper end of the driving pile 11 carried thereon is a pile driver 34 having a driving head 36 and a driving body 38. The pile driver 34 is connected by way of a supply line 40 to a ship which floats at the surface (this is not shown). Enormous levels of noise emission are produced by that pile driving operation of the driving pile 11 by means of the pile driver 34. Particularly when driving cylindrical steel tubes like for example the driving pile 11 those emission levels are very high, in part in the region of 180 dB and more.

A gas feed device 44 is arranged in the gap between the driving pile 11 and the base pile 2. The gas feed device 44 has a feed ring 50 and a feed conduit 54 which extends to a gas source at the surface of the water (not shown). The feed ring 50 has a plurality of openings for the feed of gas under pressure into the gap between the driving pile 11 and the base pile 2. The entire region between the driving pile 11 and the base pile 2 is flooded with water so that an air curtain 56 is formed in the gap between the driving pile 11 and the base pile 2 by the feed of gas under pressure by means of the gas feed device 44.

Arranged at a spacing relative to the driving pile 2 is a noise reduction casing 42 of a material which has chloroprene rubber and polyamide fibers. Once again arranged in the gap between the noise reduction casing 42 and the base pile 2 is a gas feed device 45 corresponding to the gas feed device 44. It also has a feed ring 48 and a feed conduit 52. That gap is also flooded with sea water whereby an air curtain 58 is produced in the gap by the feed of gas under pressure by means of the gas feed device 46. The noise emission caused by the pile driver 44 is effectively reduced by the air curtain. Overall therefore in this embodiment there are four noise reduction layers: firstly the inner gas bubble curtain 56, then the sandwich base pile 2 with the noise-breaking transitions of steel-concrete-steel, then a second gas bubble curtain 58 and finally the casing 42 which also has a noise-reducing action.

In a second embodiment (see FIG. 4) the noise reduction casing 42 is formed from a plurality of segments 60a, 60b, 60c, 60d which can be axially pushed into each other. Weights 66 are provided on the noise reduction casing at a lower end thereof, in the foot region 2b of the base pile 2, in order to pull the noise reduction casing 42 in the direction of the seabed (not shown in FIG. 4). In that way the position of the noise reduction casing 42 is well held so that the gap in relation to the base pile 2 is as uniform as possible. Arranged at the upper end, in the head region 2a of the base pile 2, on the noise reduction casing, are holding cables 62 with which the noise reduction casing 42 can be held in an upright position. The individual segments 60a, 60b, 60c, 60d are formed from reinforced chloroprene rubber material so that a flow cannot press them against the driving pile 2. In addition spacers for holding the noise reduction casing 42 in spaced relationship from the base pile 2, 3, 4 can be arranged on the segments 60a, 60b, 60c, 60d, being directed inwardly, so that the noise reduction casing 42 is not pressed against the base pile 2, 3, 4 by a flow.

Screw means 64 are arranged as fixing means between the individual slightly conical segments 60a, 60b, 60c, 60d. The individual segments 60a, 60b, 60c, 60d can be fixed relative to each other by way of the screw means 64 so that in the erected condition (FIG. 4) the noise reduction casing 42 is substantially rigid and cylindrical.

The method of reducing sound emission levels when erecting a base structure 1 can therefore be performed as follows: firstly the base structure 1 mounted on an installation ship (not shown in the Figures). The noise reduction casing 42 is already mounted to the base pile 2, 3, 4 or to each base pile 2, 3, 4 respectively. The gas feed devices 44, 46 are also already pre-fitted. If the noise reduction casing 42 is formed in a manner corresponding to the FIG. 4 embodiment, it can still be in a condition of being pushed together.

Then the entire base structure 1 with driving piles 11, 12, 13 supported in the base piles 2, 3, 4, the noise reduction casings 42 and the gas feed devices 44, 46 are let down on the seabed. In that case the gaps between the driving piles 11, 12, 13 and the base piles 2, 3, 4 are flooded with sea water. If the noise reduction casing 42 is not yet in the finished mounted condition, that can now be done. The weights 66 can also be lowered. Preferably the noise reduction casing 42 is drawn apart by means of the weights 66 and only slightly held by the cables 62. The noise reduction casing 42 independently aligns itself due to the buoyancy involved.

Now the operation of producing the gas bubble curtains 56, 58 is begun. For that purpose gas under pressure, in particular compressed air, is passed by means of the gas feed devices 44, 46 into the gaps between the noise reduction casing 42 and the base pile 2, 3, 4 and between the base pile 2, 3, 4 and the driving pile 11, 12, 13. Then or at the same time the operation of driving the driving pile 11, 12, 13 is begun.

After termination of the pile driving operation the noise reduction casing 42 can be removed again, with the gas feed device 46. When the gap between the base pile 2, 3, 4 and the driving pile 11, 12, 13 is filled with concrete the gas feed device 44 remains in the gap.

FIG. 5 shows a full section of a base pile 402. Identical or similar reference numerals are denoted by reference numerals increased by 400, in that respect reference is directed in its entirety to the foregoing description. The base pile 402 is in the form of a sandwich pile and has an inner tube forming the inner layer 419 and an outer tube forming the outer layer 420. A respective sandwich connection 450a, 450b is arranged at each of the axial ends of the inner and outer tubes 419, 420 respectively. The sandwich connection 450a, 450b has a ring flange 452a, 452b which is shaped conically in cross-section and which connects the inner and outer tubes 419, 420 together. On the other side the ring flange 452a, 452b is connected with a pipe connection 451a, 451b which is in the form of a solid tube. Arranged in the intermediate space between the tubes 419, 420 are reinforcing bars 433 which extend along the longitudinal axis and which extend through openings in the ring flanges 452a, 452b. Those reinforcing bars 433 are also connected to the connecting tubes 451a, 451b.

The base pile 402 is placed on the seabed 10. Arranged in the interior of the base pile 402 is a driving pile 411 which has a bulkhead 428 in the proximity of its head end, and two air vent openings 432 arranged under the bulkhead 428. The upper region of the driving pile 411 is filled with concrete 430a. Preferably the concrete 430a is introduced to a height which approximately corresponds to twice the diameter of the driving pile 411. Concrete 430b is also introduced in the intermediate space between the driving pile 411 and the base pile 402 in order to form a fixed solid connection between the two piles 402, 411.

1. A base structure (1) for an off-shore wind power installation having at least one base pile (2, 3, 4), preferably three base piles, wherein the base pile (2, 3, 4) is of a length such that when installed at an installation location it extends from a seabed (10) to above a sea level (14), wherein the base pile (2, 3, 4) has a driving pile (11, 12, 13) which is guided in its interior at least portion-wise for anchoring in the seabed (10), and at least one support structure (5) for mounting the wind power installation,
characterised in that at least a portion of the base pile (2, 3, 4) has a wall comprising a plurality of layers (19, 20, 21), wherein there is provided at least an inner layer (19) and an outer layer (20), between which is arranged at least one intermediate layer (21) which has a sound-reducing core material, in particular concrete.

2. A base structure as set forth in claim 1 characterised in that the inner layer (19) is in the form of an inner tube and the outer tube (20) is in the form of an outer tube extending at a spacing relative to the inner tube.

3. A base structure as set forth in one of the preceding claims characterised by a gas feed device (44, 46) for feeding gas under pressure, in particular air, into a gap between base pile (2, 3, 4) and driving pile (11, 12, 13).

4. A base structure as set forth in one of the preceding claims characterised by a foaming agent feed device for feeding foaming agent, in particular soap substances, into a gap between base pile (2, 3, 4) and driving pile (11, 12, 13).

5. A base structure as set forth in claim 3 or claim 4 characterised in that the gas feed device (44, 46) has a feed ring (48, 50) and a feed hose (52, 64), wherein the feed ring (48, 50) is arranged at a foot end of the base pile (2, 3, 4) and is connected to the feed hose (52, 54).

6. A base structure as set forth in claim 5 characterised in that the feed ring (48, 50) has a plurality of gas outlets for the discharge of gas flows into the gap between the driving pile (11, 12, 13) and the base pile (2, 3, 4), wherein the gas outlets are preferably substantially uniformly distributed on a ring periphery.

7. A base structure as set forth in one of the preceding claims characterised by a noise reduction casing (42) which is substantially cylindrical and which radially externally encloses the base pile (2, 3, 4).

8. A base structure as set forth in claim 7 characterised in that a substantially cylindrical gap is formed between the base pile (2, 3, 4) and the noise reduction casing (42) and there is provided a gas feed device (46) for the feed of gas under pressure, in particular air, into said gap.

9. A base structure as set forth in claim 7 or claim 8 characterised in that the noise reduction casing (42) has a chloroprene rubber material and/or a polyamide fiber fabric.

10. A method of reducing noise emissions when erecting a base structure (1), in particular a base structure (1) as set forth in one of the preceding claims, for an off-shore wind power installation, wherein the base structure has at least one base pile (2, 3, 4) and a driving pile (11, 12, 13) guided therein, comprising the step:
generating a curtain (56, 58) of gas bubbles in a water-flooded gap between the base pile (2, 3, 4) and the driving pile (11, 12, 13).

11. A method as set forth in claim 10 and further including the step:
arranging a noise reduction casing (42) outside the base pile (2, 3, 4) in such a way that it radially substantially encloses the base pile (2, 3, 4), wherein a substantially cylindrical gap remains free between them.

12. A method as set forth in claim 11 and further including the step:
generating a curtain (56, 58) of gas bubbles, in particular air bubbles, in a water-flooded gap between the noise reduction casing (42) and the base pile (2, 3, 4).

13. A method as set forth in one of claims 1 through 12 characterised in that when driving the driving pile (11, 12, 13) the volume proportion of the gas in the gap between the noise reduction casing (42) and the base pile (2, 3, 4) and/or in the gap between the base pile (2, 3, 4) and the driving pile (11, 12, 13) is greater than 40%, preferably greater than 45%, in particular greater than 50%.

14. A method as set forth in one of claims 10 through 13 and further including the step:
introducing a foaming agent, in particular soap substances, into a water-flooded gap of the base structure (1).

15. A noise reduction apparatus for reducing sound emissions when erecting a base structure, in particular a base structure (1) as set forth in one of claims 1 through 9, for an off-shore wind power installation, comprising
a noise reduction casing (42) which is adapted to preferably substantially cylindrically radially externally enclose a base pile (2, 3, 4) and has in particular a chloroprene rubber material and/or a polyamide fiber fabric, and
at least one gas feed device (44, 46) for feeding gas under pressure, in particular air, into a gap between the base pile (2, 3, 4) and a driving pile (11, 12, 13) of the base structure (1) and/or into a gap between the noise reduction casing (42) and the base pile (11, 12, 13).
